(19) United States
(12) Patent Application Publication
(10) Pub. No.: US 2008/0084687 A1
(43) Pub. Date: Apr. 10, 2008

(54) ILLUMINATED TABLE

(76) Inventor: Neall W. Humphrey, Reno, NV (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/539,104

(22) Filed: Oct. 5, 2006

(51) Int. Cl. G09F 13/04

(52) U.S. Cl. 362/97; 362/410

(57) ABSTRACT

An illuminated table having a source of light internally disposed in an enclosed glass housing and having a protective cover sealing off the source of light from the elements.

### BACKGROUND OF THE INVENTION

1. Field of the Invention

This invention relates to illuminated tables; and more particularly, to an illuminated table which can be used indoors or outdoors wherein the source of illumination is protected from the elements.

2. Related Art

Illuminated accent tables are known in the art. Such tables are aesthetically appealing in homes and offices and the like. In U.S. Pat. No. 4,807,095 to Bell, one such table is described. The problem with the Bell table, and similar tables, such as the Broach table discussed in U.S. Pat. No. 4,120,248, is that they cannot be left outdoors where they are subject to the elements. Such tables would swiftly be rendered inoperative due to wind, dust, rain and moisture and the like affecting the electronic lighting elements of the table.

There is a need for an illuminated table which can be used indoors or out and have its electrical components protected from the elements.

### SUMMARY OF THE INVENTION

It is an object of this invention to provide an illuminated table which can be used indoors or outdoors.

It is another object of this invention to provide such a table where the lighting portion of the table is enclosed and sealed off from contacts with the elements.

These and other objects are preferably accomplished by an illuminated table having a source of light internally disposed in an enclosed glass housing and having a protective cover sealing off the source of light from the elements.

### BRIEF DESCRIPTION OF THE DRAWINGS

FIG. 1 is a perspective view of an illuminated table in accordance with the teachings of the invention;

FIG. 2 is an exploded view, partly in section, of the table of FIG. 1, two of the supporting legs not shown for convenience of illustration;

FIGS. 3 and 4 are perspective views of components of the table of FIGS. 1 and 2;

FIG. 5 is an exploded view of another type of illuminated table;

FIG. 6 is a detailed view of a portion of the table in FIG. 5 illustrating assembly thereof;

FIG. 7 is a detailed plan view of a component of the table of FIG. 5;

FIG. 8 is an exploded view of a modification of 2 components of the table of FIGS. 1 to 4;

FIGS. 9 to 11 are cross-section views of modifications of a portion of the table of FIGS. 1 to 4;

FIGS. 12 through 16 are perspective views of a portion of the table of FIGS. 1 to 4 showing other embodiments thereof.

### DETAILED DESCRIPTION OF THE PREFERRED EMBODIMENTS

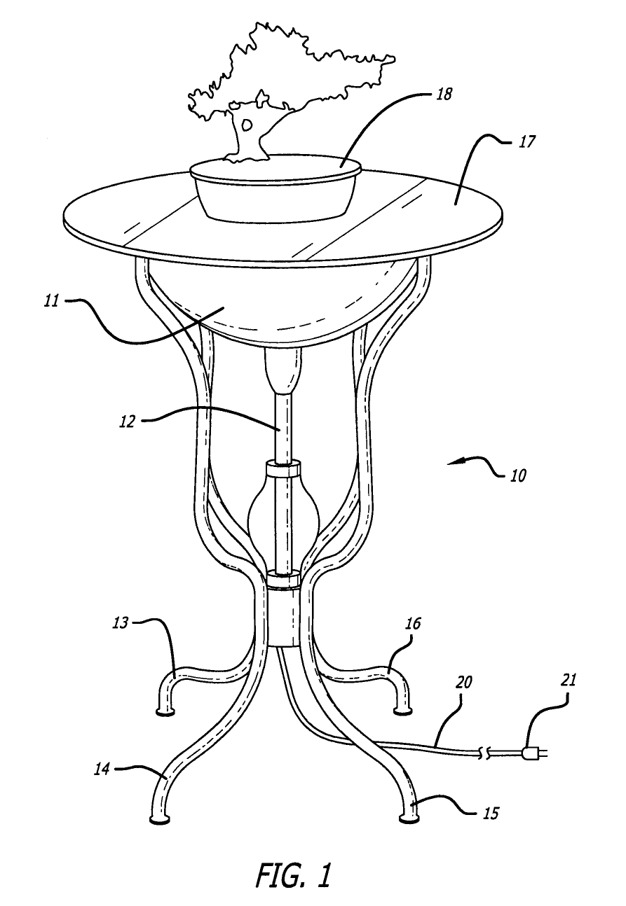

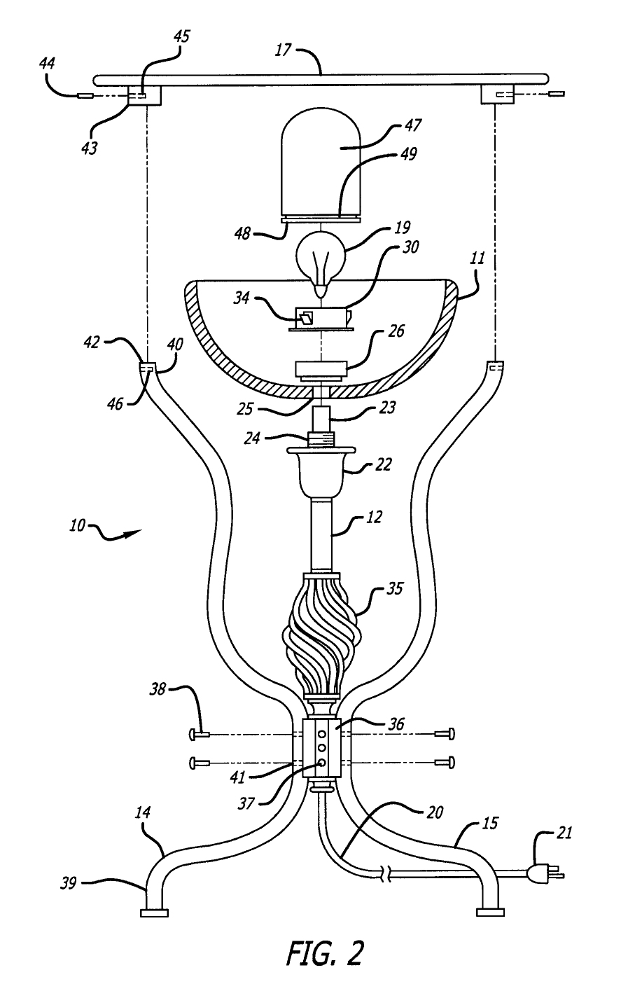

Referring now to FIG. 1 of the drawing, an illuminated table 10 is shown having a semi-spherical glass bowl 11 mounted at the top of a stand center post 12. A plurality of legs, such as 4 legs 13 through 16, support a glass top 17 on which a plant 18 or the like may be displayed. The illumination from bulb 19, See FIG. 2, lights up the top 17 and provides a pleasing accent to plant 18. An electrical conduit 20 terminates in plug 21.

Any suitable table support may be provided for bowl 11 and top 17. For example, as seen particularly in FIG. 2, center post 12 has a conventional light socket 22 at top adapted to receive bulb 19 therein as is well known in the art. Socket 22 has a sleeve portion 23 and a threaded upper socket portion 24 in which sleeve 23 is disposed. Bowl 11 has an opening 25 at bottom through which sleeve 23 and threaded socket portion 24 extend, the diameter of opening 25 being slightly greater than the diameter of threaded socket portion 24.

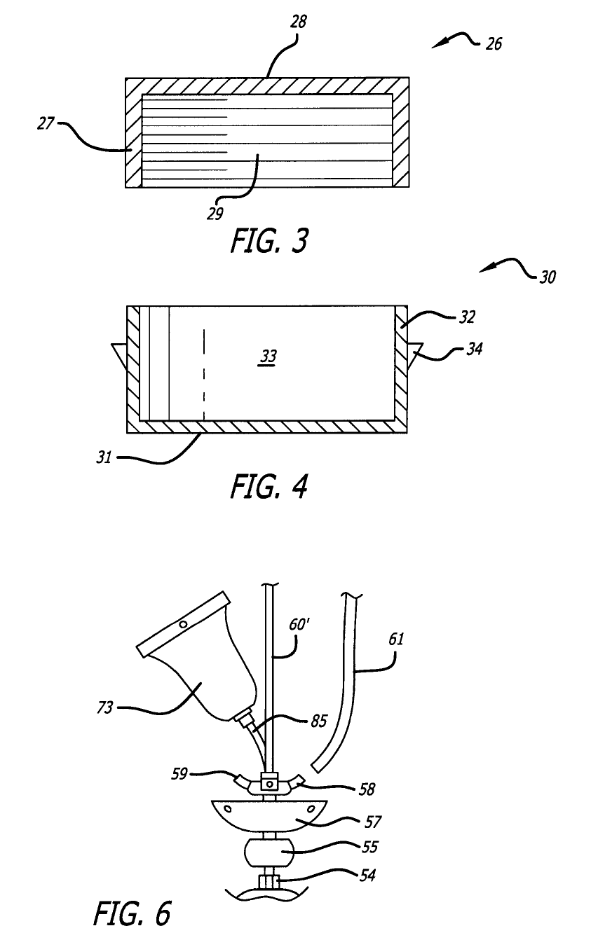

A socket ring 26 (see also FIG. 3) is provided having an outer cylindrical side wall 27, a flat upper wall 28 and open at the bottom as shown. Ring 26 may be threaded on its interior 29, if desired, such threads mating with the threads of threaded socket portion 24.

Referring again to FIG. 2, ring 26 is thus placed over sleeve 23 and either surrounds socket portion 24, or is threaded thereto, the flat portion 28 facing upwardly.

A bulb cover bracket 30 is provided and has a flat circular bottom wall 31 (FIG. 4) and a circular peripheral side wall 32 and is open at its interior 33. Side wall 32 has a plurality of upwardly extending spaced tabs 34 for reasons to be discussed.

The center post 12, below socket 22, may have a central ornate section 35 extending downwardly to a leg connecting portion 36. This portion 36 has a plurality of spaced threaded holes 37 for receiving screws 38 therein.

The supporting legs are identical. Each leg, such as leg 14, terminates at bottom in a foot portion 39, then curves upwardly to an apertured portion 42, having threaded holes 46 therethrough. Portion 40 then extends upwardly to a top supporting end 42.

Legs 13 to 16 are secured to post 12 by screws 38 threaded into aligned holes 41, 37. Conduit 20 extends upwardly through portion 36, within portions 35 and post 12 to socket 22 as is well known in the electrical art.

Top 17 can merely rest of ends 42 of legs 13 to 16, or be provided on its underside with sleeves 43 into which ends 42 are disposed. Further securement means may be provided by means of locking screws 44 which threads into aligned holes 45, 46, in sleeves 43, and ends 42, respectively.

As particularly contemplated in the present invention, after bulb 19 is inserted through bracket 30 and ring 26 and threaded into socket 22, protection for bulb 19 against the elements is provided in the form of a generally tubular bulb cover 47 having an open bottom 48 and a bottom annular rim 49. Cover 47 is adapted to snap onto bracket 30, the rim 19 snapping into tabs 34 which retain cover 47 to bracket 30 and covers bulb 19 and seals it off against the elements.

Thus, in assembly, the legs 13 to 16 are screwed to portion 36 of post 12, the light glass bowl 11 is placed around the threaded portion 24 of socket 22 and secured thereto by ring 26. The bulb cover bracket 30 is placed on top of ring 26 and light bulb 19 is screwed into socket 22. The bulb cover 47 is placed over bulb 19 and firmly pressed down so that ring 49 snaps into tabs 34. Bracket 30 may be of a metallic material so that tabs 34 are resilient and may be stamped out of the metallic bracket 30.

Glass top 17 is now placed on top of ends 42 and locked into place via screws 44.

Any suitable materials may be used. Bowl 11 and top 17, and cover 47, are of course of glass and may be clear or translucent.

It can be seen that there is disclosed an illuminated table that can be used indoors or outdoors and the electrical components are protected from the elements.

Although a particular illuminated table is disclosed in FIGS. 1 to 4, obviously various configurations may occur to an artisan.

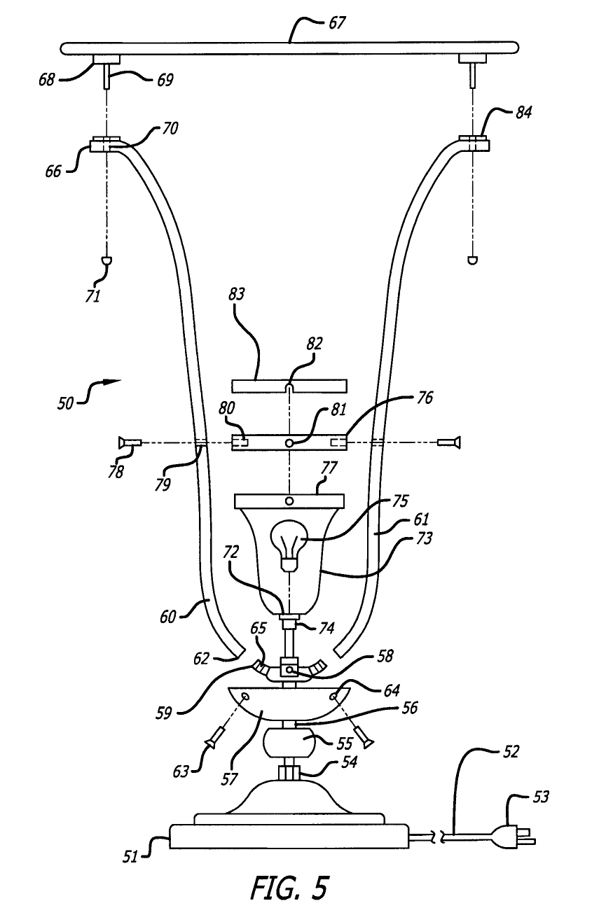

For example, as seen in FIG. 5, table 50 has a base 51 with an electrical conduit 52 extending from base 51 to plug 53. Base 51 has a central post 54, threaded at bottom, with sleeve 55 threaded thereto. Post 53 has an upper portion 56 extending through a leg bracket 57. A leg support 58 is secured to post 56 and has a plurality of spaced base pins 59 extending outwardly therefrom. A like plurality of supporting legs, such as legs 60, 61 (only 2 shown for convenience of illustration in FIG. 5—see FIG. 6 for a third leg 60′), are provided having hollow ends 62 at bottom receiving pins 59 therein. Screws 63 are threaded into aligned holes 64, in bracket 57, and holes 65 in pins 59 thereby securing support legs 60, 61 in position.

Legs 60, 61 extend upwardly and curve to terminal generally horizontal ends 66. A glass top 67 is then disposed on top of ends 66. Top 67 may have spaced rubber gaskets 68 fixed thereto with downwardly extending threaded shafts of bolts 69 which extend through aligned holes 70 in ends 66 and are secured in position by nuts 71 threaded to bolts 69.

Post 56 terminates at its upper end in a bulb socket 72 extending through and secured to the bottom of a light cup 73 by a threaded nut 74. Light cup 73 is open at top so bulb 75 can be threaded into socket 72. A light cup ring 76 is now placed on top of the rim 77 of light cup 73. A screw 78 is threaded through aligned threaded holes 79 and 80 in legs 60, 61 and ring 76. Ring 76 has a plurality of spaced pins 81 receivable in slots 82 in cap 83 which is mounted on top of ring 76.

If desired, suction cups 84 may be provided on top of ends 66. Similar cups, if desired, may be provided on ends 42 of the legs in FIG. 2.

In assembly, leg bracket 57 is secured to base 51. The light cup 73 is pulled out of the way (see FIG. 6—shaft portion 85 being resilient) before attaching legs 60, 60′, 61. The legs 60, 60′, 61 are aligned with base pins 58, 59 by angling the top of the legs 60, 60′, 61 in towards the center and ends 62 are pushed on to base pins 58, 59.

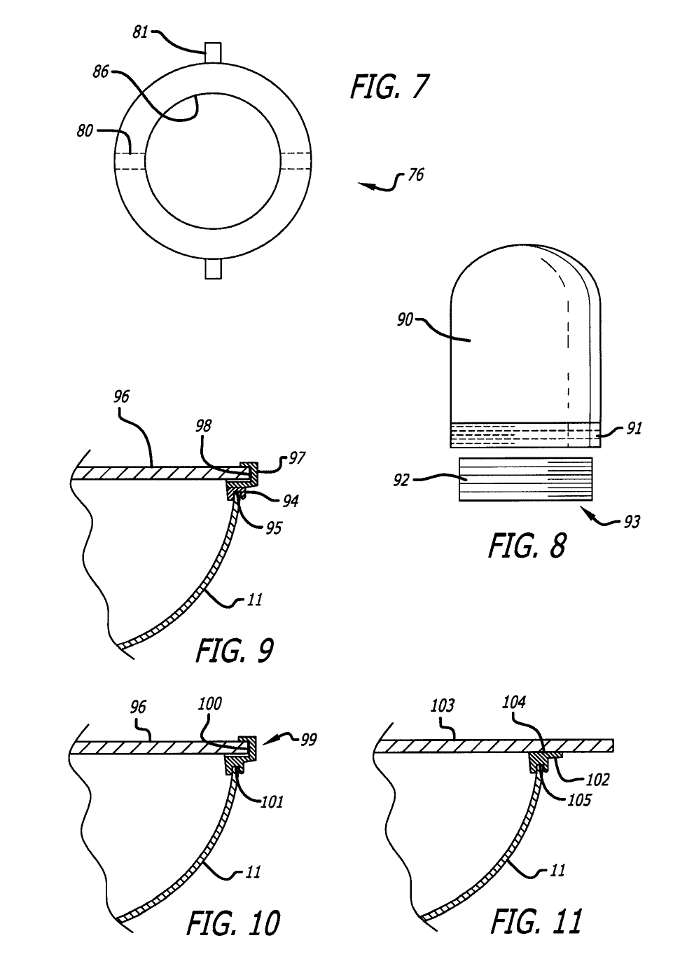

Light cup 76 (see FIG. 7) has a central opening 86 and is secured to legs 60, 60′, 61 before insertion of bulb 75.

Although cover 47 in the table of FIGS. 1 to 4 snaps into tabs 34, as seen in FIG. 8, a cover 90 and bracket 93 may be used in place of cover 47 and bracket 30. Cover 90 has a threaded bottom rim 91 on the interior of cover 90 threadably received on the outer threaded portion 92 of bracket 93.

Various methods may be used to mount the tops to the glass bowl of the table of FIGS. 1 to 4. For example, as seen in FIG. 9, bowl 11 may be provided at its upper end with annular ring 94, of a resilient or metallic material, having a groove 95 receiving the upper annular rim of bowl 11 therein. Glass top 96, the outer diameter thereof being the same as the outer diameter of bowl 11, may have an annular flange 97 encircling the outer rim of top 96, the rim being receivable within a groove 98 in flange 97. Flange 97 rests on top of ring 94.

Another embodiment is shown in FIG. 10 wherein annular flange 99 is one integral piece having an upper groove 100 receiving the rim to top 96 therein and a downwardly extending groove 101 receiving the upper rim of bowl 11 therein. As seen in FIG. 11, an annular flange 102 may be secured to the underside of top 103, which is greater in diameter than bowl 11, and has an upper flat portion 104, on which top 103 rests, and a downwardly extending annular groove 105 into which the rim of bowl 11 is disposed. All of the flanges may be of resilient material, if desired, to grip the various pieces.

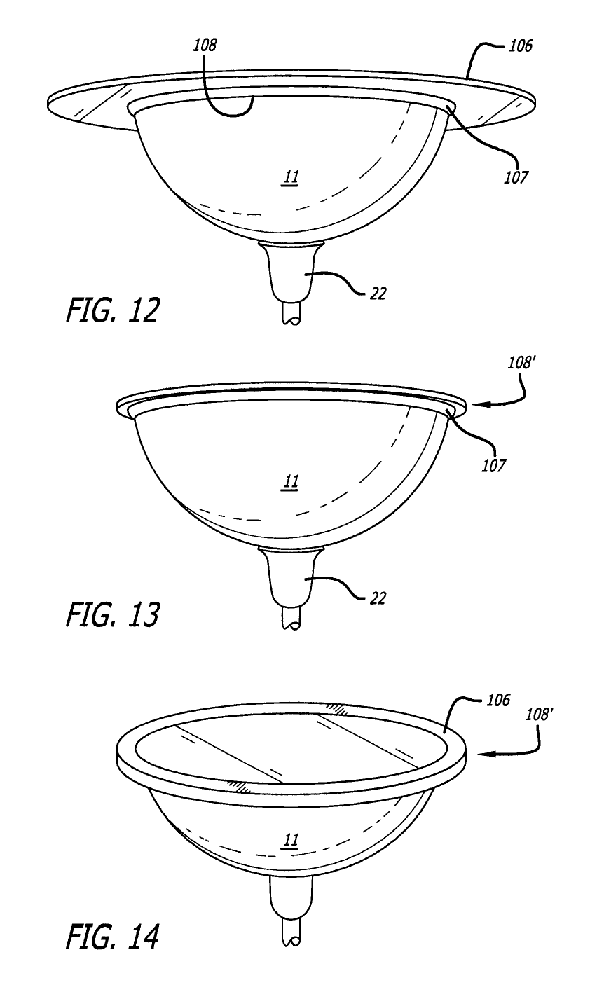

Other methods of securing a top to a bowl are shown in FIGS. 12 to 16 wherein like numerals refer to like parts of FIGS. 1 to 4. In FIG. 12, top 106 has a resilient annular gasket 107 secured to the underside thereof, the gasket having a groove 108 into which the upper rim (not shown) of bowl 11 is disposed. In the embodiment of FIGS. 13 and 14, a metallic annular ring 108′ is provided having a flat upper portion 106 and a downwardly extending annular portion 107 having an annular slot (not visible) receiving the upper rim of bowl 11 therein.

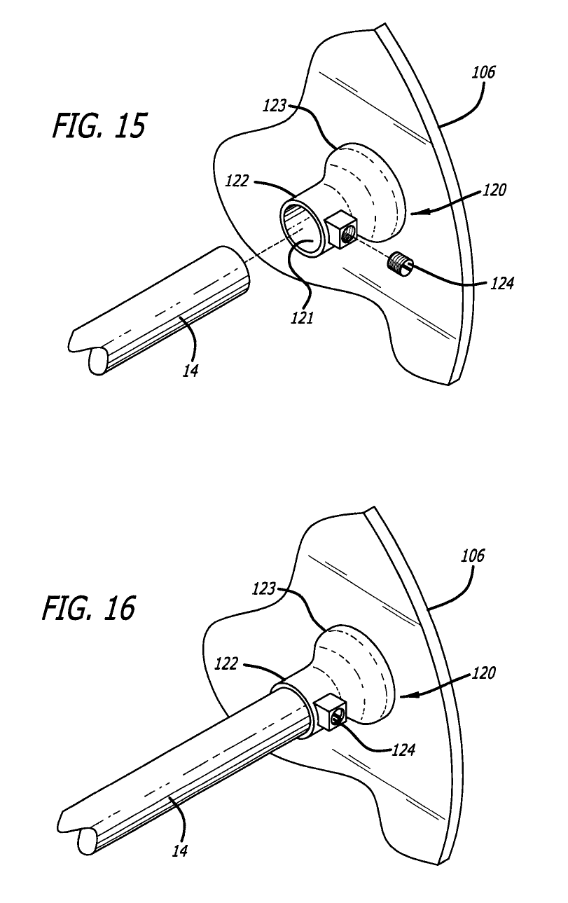

As seen in FIG. 15, a holding cup 120 may be secured to the underside of glass table top 106 in any suitable manner, such as by gluing or glass welding cup 120, which may be metallic, wood, plastic, etc., thereto. Cup 120 has an internal socket 121 in its lower end 122 and a generally circular flared upper end 123 of greater diameter than lower end 122. The upper ends of the legs, such as leg 14, fits into socket 121. As seen in FIG. 16, an adjustable screw 124 is tightened to lock leg 14 in socket 121.

In all embodiments, the combination of the top, bulb cover and glass bowl, prevent almost all moisture from entering into the interior of the tables. Thus, the bulb socket is protected from the elements.

The various tops may be of clear or translucent glass, or of various resin materials, metallic materials, marble or granite. The bowl 11 may be of metal or glass, transparent or translucent, or even of a solid opaque material.

Any suitable source of illumination may be used, such as solar, LEDS, etc. Although an electrical conduit is disclosed, a battery-powered light may be used.

Although particular embodiments of the invention have been disclosed, variations thereof may occur to an artisan and the scope of the invention should only be limited to the scope of the appended claims.

I claim:

1. An illuminated table comprising:
a support base;
an inverted bowl open at top and having a curved bottom connected to the support base;
a table top closing off the open top of said bowl;
an electrically actuated source of illumination mounted internally of said bowl, said source of illumination having a light fixture mounted therein; and
a cover mounted within said bowl substantially sealing off said light fixture from exposure to the atmosphere.

2. The table of claim 1 wherein said light fixture has a base and said cover is a glass tubular-shaped member open at one end fitting over said light fixture and fixed to a bracket surrounding the base of said light fixture.

3. The table of claim 2 wherein said light fixture is a bulb mounted in a socket disposed internally of said bowl, a ring surrounding said socket having a central hole through which said light fixture base extends, and a bracket mounted on top of said ring having a central hole through which said base extends, said cover being fixed to said bracket.

4. The table of claim 3 wherein said socket extends upwardly from said support base through an opening in said bowl, said socket having an internal threaded portion for receiving said light fixture base therein and another outer threaded sleeve portion, said bracket being threaded to the outer sleeve portion.

5. The table of claim 3 wherein said socket has an internal threaded portion for receiving said light fixture therein, and an outer threaded sleeve portion, said ring surrounding said outer threaded sleeve portion and having a flat upper surface against which said bracket abuts.

6. The table of claim 5 wherein said bracket is of metal and has an outer periphery and has a plurality of tabs extending upwardly and outwardly from said outer periphery, said cover having an annular rim snap fitting between said tabs.

7. The table of claim 5 wherein said ring is threaded to said outer threaded sleeve portion.

8. The table of claim 1 wherein said top, said bowl and said cover are of glass.

9. The table of claim 7 wherein said glass is translucent.

10. The table of claim 1 wherein said tabs extending upwardly and outwardly, from said out periphery, said cover having an annular rim snap fitting between said tabs.

11. The table of claim 1 wherein said support base is supporting by a plurality of spaced legs connected thereto.

12. The table of claim 1 wherein said support base has a central post terminating at top is a light socket extending through an opening in the bottom of said bowl receiving said source of illumination therein and at bottom in a leg connector to which said legs are connected.

13. The table of claim 11 wherein said legs terminate at top in a top end, said top resting thereon.

14. The table of claim 1 wherein said bowl has an upper rim secured to the underside of said top.

15. The table of claim 1 wherein said bowl has an upper rim and an annular ring surrounding said ring, said top being connected to said ring.

16. The table of claim 15 wherein said ring is metallic.

17. The table of claim 15 wherein said ring is of a resilient material.

18. The table of claim 1 wherein said top has an upper surface and an underside and a plurality of spaced cups fixedly secured to the underside thereof, each of said cups having a downwardly extending socket therein, and a plurality of legs supporting said top, each of said legs having an upper end fitting into respective ones of said sockets.

19. The table of claim 1 including an adjustable set screw extending through each of said cups into said sockets adjusted to lock said legs in said sockets.

20. An illuminated table comprising:
a support base;
a substantially tulip-shaped member open at top mounted to said support base, and having a socket opening at bottom;
a plurality of supporting legs terminating in upper ends connected to said support base;
a table top mounted on the upper ends of said legs;
a light socket extending through an opening in said socket opening;
a ring mounted on the open top of said member connected to said legs; and
a cap mounted on top of said ring closing off said ring and the open top of said member.
